(19) United States
(12) Patent Application Publication
(10) Pub. No.: US 2018/0025055 A1
(43) Pub. Date: Jan. 25, 2018

(54) FAULT-TOLERANT DATABASE QUERY EXECUTION PLANS USING NON-VOLATILE MEMORIES

(71) Applicant: SAP SE, Walldorf (DE)

(72) Inventor: Ahmad Hassan, Belfast (IE)

(21) Appl. No.: 15/213,626

(22) Filed: Jul. 19, 2016

(51) Int. Cl. G06F 17/30

(52) U.S. Cl. CPC G06F 17/30463; G06F 17/30501

(57) ABSTRACT

Implementations of the present disclosure include methods, systems, and computer-readable storage mediums for receiving a query, retrieving an annotated query execution plan (QEP) that is associated with the query, the annotated QEP including a plurality of operators in respective lines, which are executed to provide a query result, at least one line having annotations for check-pointing an intermediate result provided by a respective operator, and determining that a power failure occurred during execution of the annotated QEP in an in-memory database system, and in response: determining that a checkpoint for the at least one line is stored in non-volatile memory (NVM), retrieving the intermediate result provided by the respective operator from the NVM, and restarting execution of the annotated QEP using the intermediate result as input to an operator provided in a line following the at least one line.

### BACKGROUND

Enterprises may operate enterprise systems to provide software functionality to customers and employees. An enterprise system may include back-end enterprise servers that host enterprise applications such as enterprise resource planning (ERP) systems, client-relationship management (CRM) systems, product lifecycle management (PLM) systems, supply chain management (SCM) systems, supplier relationship management (SRM) systems, and so forth. During the execution of an enterprise application, application data may be placed in or accessed from the main memory of the enterprise server, such that the application data is immediately accessible by processors of the enterprise server.

Increasingly, large amounts of application data are stored in the main memory of enterprise servers. Main memory may include dynamic random access memory (DRAM), which consumes a relatively high amount of static energy both in active and idle states due to continuous leakage and refresh power. Various byte-addressable non-volatile memory (NVM) technologies promise near-zero static energy and persistence. However, NVM may exhibit high latency and high dynamic energy relative to DRAM.

### SUMMARY

Implementations of the present disclosure include computer-implemented methods for fault-tolerant query execution plans (QEPs) using non-volatile memory (NVM). In some implementations, methods include actions of receiving a query, retrieving an annotated query execution plan (QEP) that is associated with the query, the annotated QEP including a plurality of operators in respective lines, which are executed to provide a query result, at least one line having annotations for check-pointing an intermediate result provided by a respective operator, and determining that a power failure occurred during execution of the annotated QEP in an in-memory database system, and in response: determining that a checkpoint for the at least one line is stored in non-volatile memory (NVM), retrieving the intermediate result provided by the respective operator from the NVM, and restarting execution of the annotated QEP using the intermediate result as input to an operator provided in a line following the at least one line.

These and other implementations may each optionally include one or more of the following features: actions further include providing the annotated QEP by: retrieving a QEP associated with the query, executing the QEP in the in-memory database system, for each operator in the QEP, determining a cost, and selectively annotating one or more lines based on costs determined for respective operators; the cost includes a time to execute a respective operator to provide an intermediate result; a line is annotated in response to a cost of a respective operator exceeding a threshold; the annotations include a persist annotation inserted in a line immediately preceding the at least one line, and a commit annotation inserted in a line immediately following the at least one line; actions further include retrieving metadata associated with the intermediate results, the metadata including session information and a process state; and actions further include providing a query result to the query upon completing execution of the annotated QEP.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example memory architecture in accordance with implementations such as those of the present disclosure.

FIG. 2 depicts an example architecture for scheduling data processing functions of a query execution plan (QEP) in a hybrid main memory system in accordance with implementations such as those of the present disclosure.

FIG. 3 depicts an example process that can be executed in accordance with implementations such as those of the present disclosure.

FIG. 4 depicts an example process that can be executed in accordance with implementations such as those of the present disclosure.

FIG. 5 is a schematic illustration of example computer systems that may be employed for implementations such as those of the present disclosure.

Like reference symbols in the various drawings indicate like elements.

### DETAILED DESCRIPTION

Implementations of the present disclosure are directed to scheduling the execution of data processing functions in a hybrid main memory system that includes multiple types of physical memory (e.g., dynamic random access memory (DRAM), non-volatile memory (NVM)). More particularly, implementations of the present disclosure are directed to fault-tolerant query execution plans (QEPs) using NVM. In some implementations, and as described in further detail herein, actions include receiving a query, retrieving an annotated query execution plan (QEP) that is associated with the query, the annotated QEP including a plurality of operators in respective lines, which are executed to provide a query result, at least one line having annotations for check-pointing an intermediate result provided by a respective operator, and determining that a power failure occurred during execution of the annotated QEP in an in-memory database system, and in response: determining that a checkpoint for the at least one line is stored in non-volatile memory (NVM), retrieving the intermediate result provided by the respective operator from the NVM, and restarting execution of the annotated QEP using the intermediate result as input to an operator provided in a line following the at least one line.

DRAM scaling may be used to store and manage application data in main memory of enterprise servers. Given the limits of DRAM scaling, in some cases byte-addressable NVM may be employed in main memory to at least partly replace or supplement the DRAM. However, NVM has certain disadvantages, which may vary among various NVM technologies. Disadvantages of NVM may include high latency and high dynamic energy for NVM accesses. NVM may also exhibit reduced memory bandwidth and a faster wear-out of NVM devices in comparison to DRAM. NVM also has advantages. For example, NVM may scale to smaller feature sizes and may exhibit a significantly decreased lower static energy due to the absence of refresh operations. In some cases, the static energy of NVM may be approximately 100 times lower than that of DRAM.

Implementations of the present disclosure employ a hybrid main memory system, including both DRAM and NVM, to exploit the advantages of NVM while mitigating its disadvantages. Incorporating NVM in a hybrid main memory system may allow the system to scale to higher storage capacities, given the scalability and high density nature of NVM. Unlike DRAM, NVM is characterized by low leakage power and no refresh power, due to the type of storage technology employed in NVM. Accordingly, a hybrid main memory system that includes NVM may operate at a lower static power compared to a pure DRAM system. However, NVM exhibits asymmetric read and write latencies, such as higher write latencies than read latencies. The read latency of NVM may be similar to that of DRAM, where the write latency of NVM may be considerably higher than that of DRAM.

Implementations of the present disclosure can be used in hybrid main memory systems, including DRAM and NVM, for example, to support the operations of one or more applications executing in an enterprise environment, or any other appropriate computing environment. For example, application(s) may employ an in-memory database that is on a hybrid main memory system. Use of such an in-memory database may enable application(s) to access the database with lower latency than may be exhibited when accessing a database stored in a disk storage device. Implementations of the present disclosure may analyze one or more data processing functions, which may be included in a QEP of an application. A data processing function, which may also be referred to as a function or an operator, may include any number of data access operations such as read operations and write operations.

In-memory computing has significantly influenced the design of enterprise applications in terms of functionality, real-time process management, and real-time decision making. In some examples, in-memory computing platforms enable real-time analysis of large volumes of data, planning, and forecasting, among other features. In some examples, real-time data analytics attempt to make knowledge available with sub-second (and even sub-millisecond) response time. For example, real-time enterprise resource planning (ERP) enables enterprises to view every change in the enterprise as soon as it occurs, and has become a key attribute in the success of the enterprise. In the business context, real-time access to business information helps gain competitive advantage through efficient and improved decision making, product pricing, risk management, product lifecycle, customer feedback, customer engagement, brand development, product pricing, and reduced total cost of ownership (TCO).

To provide further context for implementations of the present disclosure, NVM provides persistence (like traditional disk-based memory), and provides byte addressability (like conventional DRAM). Example NVMs include phase change memory (PCM), spin transfer torque memory (STT-RAM), and memristors. Research studies have explored resistance-based memories in contrast to capacitance-based memories. For example, DRAM uses capacitance to store electric charge, which requires continuous power due to leakage. NVM uses resistance rather than capacitance for bit representation. Both DRAM and NVM consume static and dynamic energy. NVM memories provide non-volatility, which means that they don't lose data upon power failure. For example, power can be cut or switched off/on without losing data. DRAM, on the other hand, is volatile and loses data as soon as charge is lost. Moreover, DRAM needs continuous refresh power in order keep data alive, because capacitors continuously leak power with time.

Accordingly, NVM provides a unique way of persistence as compared to disk-based memory (e.g., hard disks). Because NVM is byte addressable, data can be persisted at the level of individual bytes. This means that the CPU loads and stores operations, which can be directly persisted on the NVM. As discussed in further detail herein, implementations of the present disclosure leverage this for database optimization, and achieving fault-tolerance at the level of byte granularity.

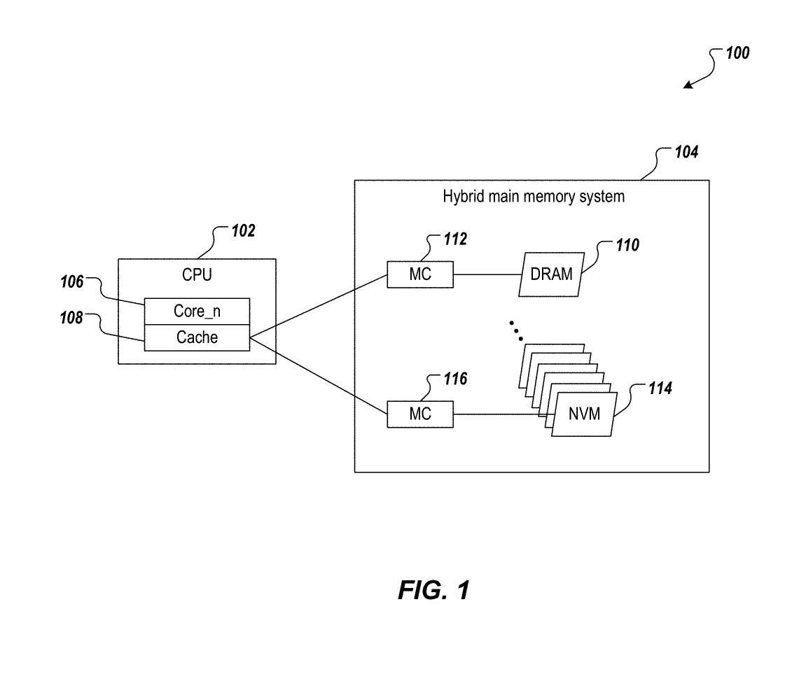

FIG. 1 depicts an example memory architecture 100 that may be implemented within an enterprise server or other type of computing device(s). In the example of FIG. 1, the example memory architecture 100 includes a central processing unit (CPU) 102 and a hybrid main memory system 104. The CPU 102 includes a core 106 having a respective cache 108. Although a single core 106 and respective cache 108 is depicted, it is appreciated that the CPU 102 may include multiple cores 106, each with a respective cache 108. Further, although a single CPU 102 is depicted, it is appreciated that computing device(s) may include multiple CPUs 102. The main memory system 104 includes DRAM 110 with a respective memory controller (MC) 112, and NVM 114 with a respective MC 116. In some cases, a cache 108 accesses (e.g., reads, writes, deletes, etc.) data in the DRAM 110 through the MC 112, and accesses data in the NVM 114 through the MC 116. The hybrid main memory system 104 may include any number of instances, or cells, of DRAM and NVM, to provide any amount of memory for use by the CPU(s) 102.

In some examples, the example memory architecture 100 may support an in-memory database that uses main memory for data storage. Main memory may include one or more types of random access memory (RAM) that communicates with one or more processors, e.g., CPU(s), over a memory bus. An in-memory database system may be contrasted with database management systems that employ a disk storage mechanism. In some examples, in-memory database systems may be faster than disk storage databases, because internal optimization algorithms may be simpler and execute fewer CPU instructions. In some examples, accessing data in an in-memory database system may reduce or eliminate seek time when querying the data, providing faster and more predictable performance than disk-storage databases. An in-memory database may include a row-oriented database, in which data is stored in any number of rows or records. An in-memory database may also include a column-oriented in-memory database, in which data tables are stored as sections of columns of data (rather than as rows of data). An example in-memory database system is HANA™, provided by SAP™ SE of Walldorf, Germany.

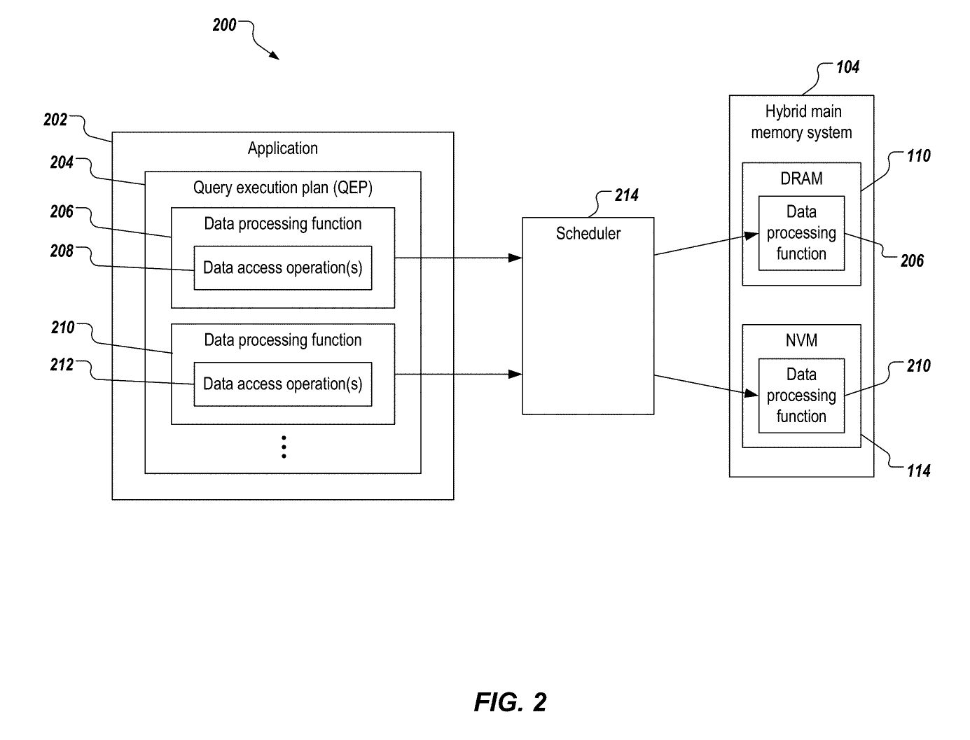

FIG. 2 depicts an example architecture 200 for executing, or scheduling for execution, one or more data processing functions of a QEP included in an application. The example of FIG. 2 is described in further detail in commonly assigned, U.S. patent application Ser. No. 14/831,624, filed on Aug. 20, 2015, the disclosure of which is expressly incorporated herein by reference in the entirety. As shown in the example of FIG. 2, the example architecture 200 may include an application 202. The application 202 may execute on one or more processors, such as the CPU 102. The application 202 may include a QEP 204 that comprises any number of data processing functions. In the example of FIG. 2, the QEP 204 includes at least two data processing functions 206, 210. A data processing function may include any number of data access operations. Data access operations may include any type of operation to access data present in the hybrid main memory system 104. In some examples, data access operations include read operations to retrieve any amount of data. In some examples, data access operations include write operations to place any amount of new data into the hybrid main memory system 104, or to update any amount of existing data in the hybrid main memory system 104. In some examples, data access operations include delete or drop operations to remove any amount of data from the hybrid main memory system 104. In some examples, data access operations include other types of operations, including, but not limited to: join operations of any type; sorting or ordering operations; mathematical operations on the data; difference operations to identify differences (e.g., deltas) between sets of data; and so forth. In the example of FIG. 2, the data processing function 206 includes a first set of one or more data access operations 208, and the data processing function 210 includes a second set of one or more data access operations 212.

In some implementations, the application 202 may provide the QEP 204, or one or more data processing functions of the QEP 204, to a scheduler 214. The scheduler 214 may execute on one or more computing devices, and may execute on the same or different computing device(s) as the application 202. In some implementations, the scheduler 214 may include an executable library, interface, or other software module that is called from the application 202 to cause the execution of data processing function(s) of the QEP 204 in various portion(s) of the hybrid main memory system 104.

As introduced above, implementations of the present disclosure are directed to fault-tolerant QEPs using NVM. More particularly, and as described in further detail herein, an annotated QEP (aQEP) can be provided for a respective QEP, the aQEP providing checkpoints for respective operators. In some examples, each checkpoint is associated with an operator that is determined to be a time-consuming operator. In some examples, a time-consuming operator includes an operator having a time of execution that exceeds a threshold time. In some implementations, each checkpoint provides that, at the end of the execution of the respective operator, the result of the operator is persisted (e.g., stored in NVM). In the event of power loss (e.g., power failure), if no checkpoint is persisted, the aQEP is executed from the beginning, and, if one or more checkpoints are persisted, the result of the last-persisted checkpoint is retrieved from memory, and the aQEP is executed beginning from the next operator (e.g., the operator that is immediately after the operator associated with the checkpoint).

In some implementations, the time-consuming operators of a QEP are determined. For example, an in-memory database platform implements a computer-executable profiling tool to determine the time it takes for each operator of a QEP to execute. In some examples, a dictionary of the QEP is provided, the dictionary having the line number of each operator of the QEP as a key, and a time taken to execute each operator (line) of the QEP. For example, the dictionary is provided as a table of tuples, each tuple including a line number (associated with a respective operator in the QEP) and a respective execution time. In some implementations, the time-consuming operators of the QEP are determined based on the execution times, and a checkpoint is provided for each such operator. More particularly, and as described in further detail herein, an aQEP is provide for the QEP, and includes annotations for identifying time-consuming operators, and persisting the results of time-consuming operators as checkpoints.

To illustrate implementations of the present disclosure, an example QEP and respective aQEP are discussed in further detail. The example QEP is associated with a benchmark query that can be processed in accordance with implementations of the present disclosure. Example benchmark queries can include queries provided in the TPC Benchmark H (TPC-H) provided by the Transaction Processing Performance Council of San Francisco, Calif. The TPC-H is a decision support benchmark that includes a set of business oriented ad-hoc queries (e.g., a set of benchmark queries), and concurrent data modifications. The TPC-H is described as being representative of decision support systems that examine large volumes of data, execute queries with a high degree of complexity, and provide answers to critical business questions. Although implementations are described in further detail herein with reference to an example TPC-H benchmark query, it is contemplated that implementations of the present disclosure can be realized using any appropriate query and respective QEP.

To illustrate implementations of the present disclosure, query number 11 (Q11) of the TPC-H will be discussed. In some examples, the TPC-H includes a set of 22 queries, where Q11 is entitled “Important Stock Identification Query,” and is executed to find the most important subset of suppliers' stock in a given nation. More specifically, Q11 finds, from scanning the available stock of suppliers in a given nation, all the parts that represent a significant percentage of the total value of all available parts, and the query result displays the part number and the value of those parts in descending order of value. To execute Q11, a QEP is provided. Listing 1, below, provides excerpts from the QEP of Q11:
1 X_33:=calc.str (3, 7, 0, 0, “GERMANY”, 25);
2 X_167:=calc.str (3, 7, 0, 0, “GERMANY”, 25);
3 X_1:=sql.mvc ( );
24 X_39:=sql.projectdelta (X_28, X_31, X_34, rl_62, X_37);
25 (X_80, rl_208):=algebra.join (X_79, X_39);
26 X_55:=sql.bind (X_1, “sys”, “partsupp ”, “ps_supplycost”, 0);
46 X_27:=algebra.leftfetchjoin (X_25, X_2);
47 (X_40, rl_74):=algebra.join (X_27, X_39);
48 X_65:=algebra.leftfetchjoin (rl_74, X_64);
79 sql.rsColumn (X_108, “sys.”, “value”, “decimal”, 19, 2, X_107);
80 X_119:=io.stdout ( );

### Listing 1: Excerpts of QEP for TPC-H Q11

In accordance with implementations of the present disclosure, a profiling tool is used to determine the execution time of each line (operator) of a QEP. In some examples, the profiling tool is provided as an LLVM tool (e.g., LLVM pass). In some examples, executing the QEP for Q11 reveals that line 25 is associated with an execution time of approximately 65,000 milliseconds (ms), and that line 47 is associated with an execution time of approximately 53,000 ms, while the remaining lines are each largely associated with execution times of less than approximately 500 ms. Overall, it can be determined that lines 25 and 47 together account for approximately 99% of the total execution time for the QEP of Q11. Consequently, lines 25 and 47 can be determined to be time-consuming operators of the QEP.

In accordance with implementations of the present disclosure, one or more operators (lines) of a QEP are determined to be time-consuming operators, for which respective checkpoints are to be implemented. In some examples, the execution time of each operator can be compared to a threshold execution time, and, if the execution time of an operator exceeds the threshold execution time, the operator is determined to be a time-consuming operator. In some examples, the threshold execution time can be determined based on the execution times of all of the operators of the QEP. As one example, the threshold execution time can be determined as a specified percentage over an average execution time for all operators of the QEP. For example, if the average execution time is approximately 2,000 ms, the threshold execution time can be provided as 50% over the average execution time (e.g., 3,000 ms), such that any operator having an execution time over 3,000 ms is determined to be a time-consuming operator.

Continuing with the example of Q11, because lines 25 and 47 are time-consuming operators, the respective results of line 25 and 47, when executed, can be persisted using NVM during execution of the QEP.

Accordingly, implementations of the present disclosure introduce notions of “Persist Region” and “Commit.” In some examples, segments of the QEP are identified as segments that are to be persisted, and are annotated as such. In some examples, and as described in further detail herein, such segments are check-pointed and persisted to ensure that the intermediates results produced by the operators of the segment are persisted in NVM. In some examples, an intermediate result is a result of one or more operators of the QEP that have been executed before complete execution of the QEP. In some implementations, intermediate results are persisted using a dedicated persistence thread in the background, such that any persistence delay does not affect continued execution of the aQEP. In this manner, there is no slowdown in the query execution engine, which could otherwise results from the added persistence layer. In some implementations, metadata about the aQEP and the ongoing query is also stored, which metadata can be used to resume execution of the aQEP in the event of a stoppage (e.g., during recovery after a power failure). Check-pointing and recovery algorithms are described in further detail herein.

Continuing with the example of Listing 1 above, and as noted above, it is determined that lines 25 and 47 include the time-consuming operators of the QEP. Consequently, and in accordance with implementations of the present disclosure, the QEP can be annotated to provide an aQEP with embedded persistence and related application program interface (API) calls. Listing 2, below, provides excerpts from an example aQEP of Q11:
1 X_33:=calc.str (3, 7, 0, 0, “GERMANY”, 25);
2 X_167:=calc.str (3, 7, 0, 0, “GERMANY”, 25);
3 X_1:=sql.mvc ( );
24 X_39:=sql.projectdelta (X_28, X_31, X_34, rl_62, X_37);
25 Operator.persistAll( );
26 (X_80, rl_208):=algebra.join (X_79, X_39);
27 Operator.commitAll( );
28 X_55:=sql.bind (X_1, “sys”, “partsupp ”, “ps_supplycost”, 0);
48 X_27:=algebra.leftfetchjoin (X_25, X_2);
49 Operator.persistAll( );
50 (X_40, rl_74):=algebra.join (X_27, X_39);
51 Operator.commitAll( );
52 X_65:=algebra.leftfetchjoin (rl_74, X_64);
83 sql.rsColumn (X_108, “sys.”, “value”, “decimal”, 19, 2, X_107);
84 X_119:=io.stdout ( );

### Listing 2: Excerpts of aQEP for TPC-H Q#11

As depicted in Listing 2, implementations of the present disclosure provide a marker ‘persistAll’ and a marker ‘commitAll’ to indicate the check-pointing of a respective operator (a time-consuming operator). For example, lines 25 and 47 include the time-consuming operators of the excerpted QEP of Listing 1, which are now provided as lines 26 and 50, respectively in Listing 2, with lines 25 and 27 providing the check-point annotations for line 26, and lines 49 and 51 providing the check-point annotation for line 50.

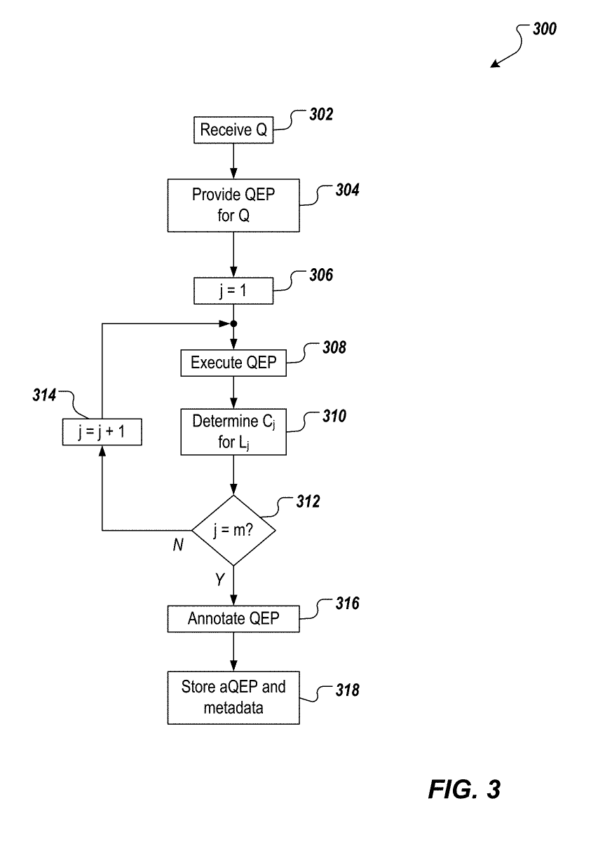

FIG. 3 depicts an example process 300 for providing an aQEP in accordance with implementations such as those of the present disclosure. In some implementations, the example process 300 may be performed using one or more computer-executable programs executed using one or more computing devices.

A query Q is received (302). For example, a query (e.g., SQL query) can be submitted to an application from a user. In some examples, the application interacts with an in-memory database in a hybrid memory system to provide a result to the query. A QEP is provided for the Q (304). In some examples, the QEP is pre-stored in memory, and is retrieved from memory based on the Q. In some examples, the QEP includes a plurality of operations provided in respective lines L. For example, the QEP can include lines L₁, . . . , Lₘ, each line being associated with a respective operator. In some examples, the operators of all lines L₁, . . . , Lₘ are performed to provide the query results. In some examples, the operators of lines L₁, . . . , Lₘ₋ₓ (where x is an integer that is greater than zero and less than m-1) to provide an intermediate result. In some examples, a result of an operator of a line L₁, . . . , Lₘ₋₁, is an intermediate result that is provided to an operator of a next line (e.g., L₂, . . . , Lₘ), and the result of the operator of the last line Lm is provided as the query result. In some examples, and as described herein, one or more intermediate results can be persisted during execution of the QEP.

A counter j is set equal to 1 (306). The QEP is executed (308). For example, operators of the QEP are executed in line order (e.g., beginning with L₁) to incrementally provide respective intermediate results. In some examples, the QEP is executed as described above with reference to FIG. 2. A cost Cⱼ is determined for an executed line Lⱼ (310). In some examples, is provided in terms of time, and is the time required to execute the operator of Lⱼ. In some examples, Cᵢ is determined using a profiling tool (e.g., computer-executable code) that the in-memory database system and/or application are instrumented with. For example, the profiling tool can be loaded for execution into the in-memory database system, and can determine costs C for operators as respective lines of a QEP are executed. It is determined whether the counter j is equal to m (312). In other words, it is determined whether all lines L of the QEP have been executed and respective costs C determined. If j is not equal to m, j is incremented (314), and the example process loops back to consider the next line of the QEP.

If j is equal to m, the QEP is annotated to provide an aQEP (316). For example, one or more time-consuming operators are identified based on respective costs. That is, for example, and as described above, each cost can be compared to a threshold, and if a cost exceeds the threshold, the associated operator can be identified as a time-consuming operator. In some examples, annotations (or markers) are inserted before and after each line that is associated with a time-consuming operator. Example annotations include Operator.persistAll( ) and Operator.commitAll( ), provided above with reference to Listing 2. In some examples, it can be the case that no cost exceeds the threshold. In such cases, no operators are determined to be time-consuming operators, and the aQEP includes no annotations (e.g., the aQEP is identical to the QEP). The aQEP and associated metadata are stored (318). For example, the aQEP and metadata are stored in computer-readable memory, such that they are accessible at a subsequent call of Q.

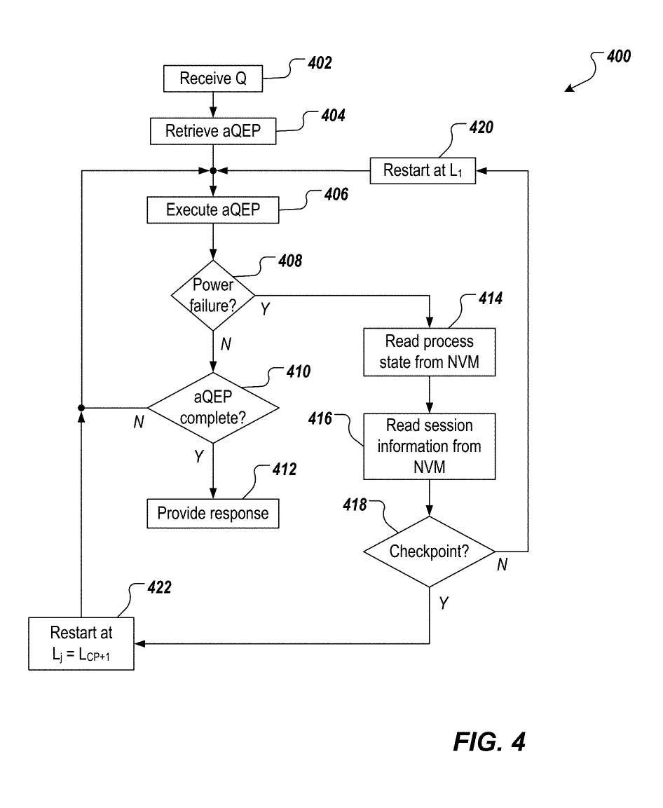

FIG. 4 depicts an example process 400 for executing a query based on a respective aQEP in accordance with implementations of the present disclosure. In some implementations, the example process 400 may be performed using one or more computer-executable programs executed using one or more computing devices.

A query Q is received (402). For example, a query (e.g., SQL query) can be submitted to an application from a user. In some examples, the application interacts with an in-memory database in a hybrid memory system to provide a result to the query. An aQEP is retrieved for the Q (404). In some examples, the aQEP is pre-stored in memory, and is retrieved from memory based on the Q that was received (e.g., using a look-up table). In some examples, the aQEP includes a plurality of operators provided in respective lines L. In some examples, the aQEP includes one or more lines associated with respective time-consuming operators, which lines are annotated, as described herein. For example, the aQEP can include lines L₁, . . . , Lₖ, each line being associated with a respective operator. In some examples, the operators of all lines L₁, . . . , Lₖ are performed to provide the query results. In some examples, the operators of lines L₁, . . . , Lk₋ₓ (where x is an integer that is greater than zero and less than k-1) to provide an intermediate result. In some examples, a result of an operator of a line L₁, . . . , Lₖ₋₁, is an intermediate result that is provided to an operator of a next line (e.g., L₂, . . . , Lₖ), and the result of the operator of the last line Lₖ is provided as the query result. In some examples, and as described herein, one or more intermediate results can be persisted during execution of the aQEP. That is, for example, if a line is annotated as a check-point (L_{cp}), the intermediate result provided by the operator of the line is stored in NVM.

The aQEP is executed (306). For example, operators of the aQEP are executed in line order (e.g., beginning with L₁) to incrementally provide respective intermediate results. In some examples, the aQEP is executed as described above with reference to FIG. 2. It is determined whether a power failure occurred (408). For example, the in-memory database system can lose power during execution of the aQEP, and before the query result is provided. If a power failure has not occurred, it is determined whether execution of the aQEP is complete (410). For example, it is determined whether operators of all lines L₁, . . . , Lₖ of the aQEP have been executed. If execution of the aQEP is complete, a response (query result) is provided (412). For example, the in-memory database system provides the query result to the application that submitted Q. If execution of the aQEP is not complete, the example process 400 loops back to continue execution of the aQEP.

If a power failure has occurred (e.g., as determined after the in-memory database system is brought back online after the power failure), a process state is read from the NVM (414), and session information is read from the NVM (416). In some examples, the process state includes a snapshot of the OS process (thread) at a particular time. In some examples, the snapshot includes the data loaded in the caches or main memory for the particular OS process. In some examples, if the process state of a process is stored on the NVM, then that information can be read back from NVM. The session information includes information used for check-pointing, and starting a process from the previous checkpoint.

It is determined whether a checkpoint was stored (418). For example, it is determined whether the NVM includes one or more checkpoints stored for the partial execution of the aQEP before the power failure. If no checkpoints are stored, the aQEP is set to restart from the beginning (e.g., line L₁) (420). If one or more checkpoints are stored, the aQEP is restarted from the line immediately following the line that was check-pointed (e.g., line L_{CP+1}) (422). More particularly, the intermediate result that was determined for the line that was check-pointed (e.g., line L_{CP}) is retrieved from memory (from NVM) and is provide as input to the operator of the next line (e.g., line L_{CP+1}). In some examples, the multiple lines had been check-pointed before the power failure, the last line to have been check-pointed is used to determine the restart line of the aQEP.

Using Listing 2, as an example, the example aQEP can be executed through line 67 before a power failure occurs. Consequently, lines 26 and 50 are both check-pointed, and the intermediate results of the respective operators are stored in memory (e.g., NVM) before the power failure. After the in-memory database system is brought back online, it can be determined that line 50 was the last check-pointed line, and the intermediate result of the operator of line 50 can be retrieved from memory. The aQEP can restart at line 52 with the intermediate result of the operator of line 50 being provided as input to the operator of line 52.

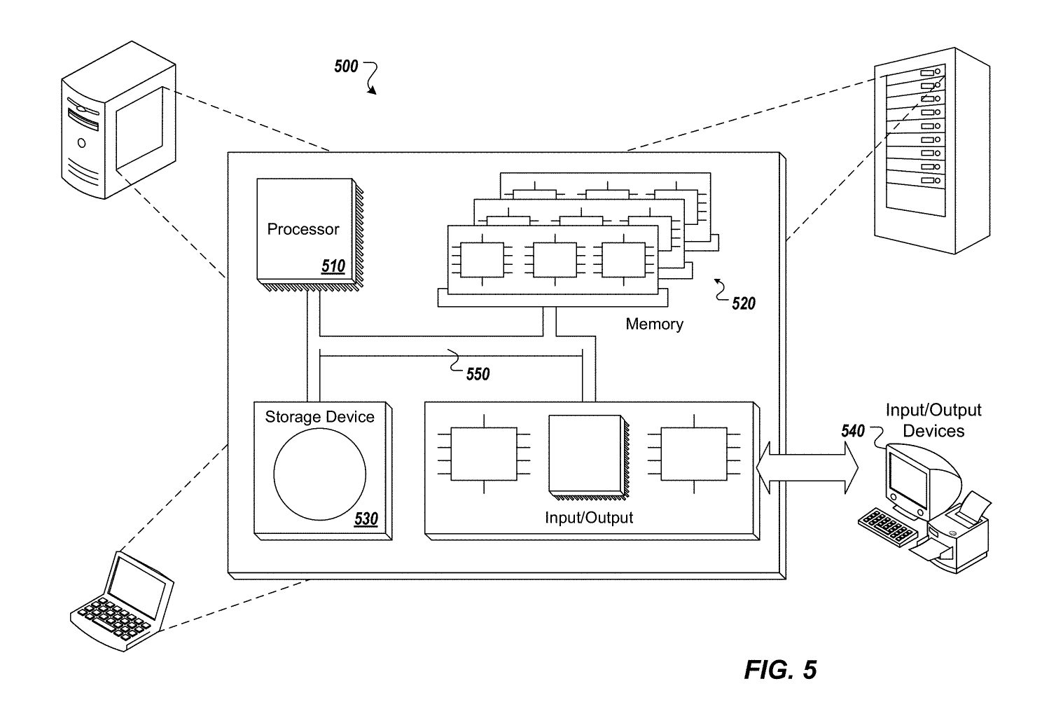

FIG. 5 depicts a schematic diagram of an example computing system 500. The system 500 may be used to perform the operations described with regard to one or more implementations of the present disclosure. For example, the system 500 may be included in any or all of the server components, or other computing device(s), discussed herein. The system 500 may include one or more processors 510, one or more memories 520, one or more storage devices 530, and one or more input/output (I/O) devices 540. The components 510, 520, 530, 540 may be interconnected using a system bus 550.

The processor 510 may be configured to execute instructions within the system 500. The processor 510 may include a single-threaded processor or a multi-threaded processor. The processor 510 may be configured to execute or otherwise process instructions stored in one or both of the memory 520 or the storage device 530. Execution of the instruction(s) may cause graphical information to be displayed or otherwise presented via a user interface on the I/O device 540. The processor(s) 510 may include the CPU 102.

The memory 520 may store information within the system 500. In some implementations, the memory 520 is a computer-readable medium. In some implementations, the memory 520 may include one or more volatile memory units. In some implementations, the memory 520 may include one or more non-volatile memory units. The memory 520 may include the hybrid main memory system 104.

The storage device 530 may be configured to provide mass storage for the system 500. In some implementations, the storage device 530 is a computer-readable medium. The storage device 530 may include a floppy disk device, a hard disk device, an optical disk device, a tape device, or other type of storage device. The I/O device 540 may provide I/O operations for the system 500. In some implementations, the I/O device 540 may include a keyboard, a pointing device, or other devices for data input. In some implementations, the I/O device 540 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors, the method comprising:
receiving, by the one or more processors, a query;
retrieving, by the one or more processors, an annotated query execution plan (QEP) that is associated with the query, the annotated QEP comprising a plurality of operators in respective lines, which are executed to provide a query result, at least one line having annotations for check-pointing an intermediate result provided by a respective operator; and
determining, by the one or more processors, that a power failure occurred during execution of the annotated QEP in an in-memory database system, and in response:
determining that a checkpoint for the at least one line is stored in non-volatile memory (NVM),
retrieving the intermediate result provided by the respective operator from the NVM, and
restarting execution of the annotated QEP using the intermediate result as input to an operator provided in a line following the at least one line.

2. The method of claim 1, further comprising providing the annotated QEP by:
retrieving a QEP associated with the query;
executing the QEP in the in-memory database system;
for each operator in the QEP, determining a cost; and
selectively annotating one or more lines based on costs determined for respective operators.

3. The method of claim 2, wherein the cost comprises a time to execute a respective operator to provide an intermediate result.

4. The method of claim 2, wherein a line is annotated in response to a cost of a respective operator exceeding a threshold.

5. The method of claim 1, wherein the annotations comprise a persist annotation inserted in a line immediately preceding the at least one line, and a commit annotation inserted in a line immediately following the at least one line.

6. The method of claim 1, further comprising retrieving metadata associated with the intermediate results, the metadata comprising session information and a process state.

7. The method of claim 1, further comprising providing a query result to the query upon completing execution of the annotated QEP.

8. A non-transitory computer-readable storage medium coupled to one or more processors and having instructions stored thereon which, when executed by the one or more processors, cause the one or more processors to perform operations comprising:
receiving a query;
retrieving an annotated query execution plan (QEP) that is associated with the query, the annotated QEP comprising a plurality of operators in respective lines, which are executed to provide a query result, at least one line having annotations for check-pointing an intermediate result provided by a respective operator; and
determining that a power failure occurred during execution of the annotated QEP in an in-memory database system, and in response:
determining that a checkpoint for the at least one line is stored in non-volatile memory (NVM),
retrieving the intermediate result provided by the respective operator from the NVM, and
restarting execution of the annotated QEP using the intermediate result as input to an operator provided in a line following the at least one line.

9. The computer-readable storage medium of claim 8, wherein operations further comprise providing the annotated QEP by:
retrieving a QEP associated with the query;
executing the QEP in the in-memory database system;
for each operator in the QEP, determining a cost; and
selectively annotating one or more lines based on costs determined for respective operators.

10. The computer-readable storage medium of claim 9, wherein the cost comprises a time to execute a respective operator to provide an intermediate result.

11. The computer-readable storage medium of claim 9, wherein a line is annotated in response to a cost of a respective operator exceeding a threshold.

12. The computer-readable storage medium of claim 8, wherein the annotations comprise a persist annotation inserted in a line immediately preceding the at least one line, and a commit annotation inserted in a line immediately following the at least one line.

13. The computer-readable storage medium of claim 8, wherein operations further comprise retrieving metadata associated with the intermediate results, the metadata comprising session information and a process state.

14. The computer-readable storage medium of claim 8, wherein operations further comprise providing a query result to the query upon completing execution of the annotated QEP.

15. A system, comprising:
a computing device; and
a computer-readable storage device coupled to the computing device and having instructions stored thereon which, when executed by the computing device, cause the computing device to perform operations comprising:
receiving a query;
retrieving an annotated query execution plan (QEP) that is associated with the query, the annotated QEP comprising a plurality of operators in respective lines, which are executed to provide a query result, at least one line having annotations for check-pointing an intermediate result provided by a respective operator; and
determining that a power failure occurred during execution of the annotated QEP in an in-memory database system, and in response:
determining that a checkpoint for the at least one line is stored in non-volatile memory (NVM),
retrieving the intermediate result provided by the respective operator from the NVM, and
restarting execution of the annotated QEP using the intermediate result as input to an operator provided in a line following the at least one line.

16. The system of claim 15, wherein operations further comprise providing the annotated QEP by:
retrieving a QEP associated with the query;
executing the QEP in the in-memory database system;
for each operator in the QEP, determining a cost; and
selectively annotating one or more lines based on costs determined for respective operators.

17. The system of claim 16, wherein the cost comprises a time to execute a respective operator to provide an intermediate result.

18. The system of claim 16, wherein a line is annotated in response to a cost of a respective operator exceeding a threshold.

19. The system of claim 15, wherein the annotations comprise a persist annotation inserted in a line immediately preceding the at least one line, and a commit annotation inserted in a line immediately following the at least one line.

20. The system of claim 15, wherein operations further comprise retrieving metadata associated with the intermediate results, the metadata comprising session information and a process state.
